(19) United States
(12) Patent Application Publication
(10) Pub. No.: US 2025/0003284 A1
(43) Pub. Date: Jan. 2, 2025

(54) Structural component, with low emissivity materials, for use in a building structure

(71) Applicants: Vic De Zen, Woodbridge (CA); Colby De Zen, Woodbridge (CA)

(72) Inventors: Vic De Zen, Woodbridge (CA); Colby De Zen, Woodbridge (CA); Farhad Zafari, Woodbridge (CA)

(21) Appl. No.: 18/705,889

(22) PCT Filed: Oct. 28, 2022
(86) PCT No.: PCT/CA2022/051603

§ 371 Date: Apr. 29, 2024

Related U.S. Application Data
(60) Provisional application No. 63/273,793, filed on Oct. 29, 2021.
(60) Provisional application No. 63/399,559, filed on Aug. 19, 2022.

(51) Int. Cl. E06B 3/263

(52) U.S. Cl. CPC E06B 3/2632; E06B 2003/26321

(57) ABSTRACT

A structural component for use in a building structure, comprising an internal cavity, defined by a component-based cavity-defining internal wall configuration and comprising a low emissivity material disposed within the cavity. The low emissivity material defines at least a portion of a surface of the component-based cavity-defining inner wall configuration. The low emissivity material may be provided as a layer adhering to a wall configuration substrate of the component-based cavity defining the inner wall configuration. The low emissivity material may further be adhered to the component-based cavity wall configuration substrate defining the inner wall configuration using spray coating. The low emissivity material may further be provided as a surface of a composite insert disposed within the cavity, wherein the composite insert comprises the low emissivity material coupled to a substrate material.

### FIELD

The present disclosure is related to structural components for use in building structures.

### BACKGROUND

It is desirable to mitigate energy loss through fenestrations, such as windows and doors.

### SUMMARY

In one aspect, there is provided there is provided a structural component for use in a building structure, including an internal cavity, defined by a component-based cavity-defining internal wall configuration, comprising low emissivity material disposed within the cavity such that the low emissivity material defines a surface within the cavity.

In another aspect, there is provided a composite insert for emplacement within a cavity of a frame member of a structural component for use in a building structure, comprising the composite insert includes low emissivity material that is coupled to a substrate material

In another aspect, there is provided a multiple insert source material including a composite material, comprising:
low emissivity material that is coupled to a substrate material such that the low emissivity material defines at least a portion of a surface of the source material;
wherein:
   the surface is scored such that one or more portions of the source material is detachable from the source material, such that, detachment of one portion from the source material is with effect that: (i) the detached portion has at least a surface portion that is defined by low emissivity material, and (ii) a remaining portion of the multiple-insert source material is obtained, wherein the remaining portion has a surface portion that is defined by low emissivity material.

### BRIEF DESCRIPTION OF DRAWINGS

Reference will now be made, by way of example, to the accompanying drawings which show example embodiments of the present application, and in which:

FIG. 1 is a schematic illustration of a window of the present disclosure;

FIG. 2 is a cross-sectional elevation view of an embodiment of a frame counterpart, of the present disclosure, used for constructing a window;

FIG. 3 is a cross-sectional elevation view of another embodiment of a frame counterpart, of the present disclosure, used for constructing a window;

FIG. 4 is a photograph, taken in perspective, of another embodiment of a frame counterpart of the present disclosure, illustrating low emissivity material coating applied to an extrusion;

FIG. 5 is a schematic illustration of a spray gun which is usable in a method of producing a frame counterpart of the present disclosure;

FIG. 6 is a schematic illustration of an insert of the present disclosure;

FIG. 7 is a cross-sectional elevation view of another embodiment of a frame counterpart, of the present disclosure, with the insert illustrated in FIG. 6 disposed in a cavity of the frame counterpart;

FIG. 8 is a photograph, taken in perspective view, of another embodiment of a frame counterpart, of the present disclosure, with an insert disposed in the cavity of the extrusion;

FIG. 9 is an embodiment of a process of producing an embodiment of a frame counterpart of the present disclosure;

FIG. 10 is a schematic illustration of an exit template of n extruder die used in the process illustrated in FIG. 9;

FIG. 11 is another embodiment of a process of producing an embodiment of a frame counterpart of the present disclosure;

FIG. 12 is a top perspective view of an embodiment of a multiple insert source material of the present disclosure; and

FIG. 13 is a photograph illustrating detachment of an insert from an embodiment of a multiple insert source material of the present disclosure.

### DETAILED DESCRIPTION

There is provided a structural component for use in a building structure. The structural component defines a cavity, and includes low emissivity material which is disposed within the cavity such that the low emissivity material defines a surface within the cavity. In some of these embodiments, for example, the disposition of the low emissivity material within the cavity is such that an air space 203 is defined within the cavity and extends from the low emissivity material to an opposing solid surface of the structural component. Amongst other things, the presence of the air space mitigates heat conduction by the structural component. In some embodiments, for example, the structural component is part of a fenestration, such as, for example, a window. The structural component is described herein with reference to an exemplary embodiment where the structural component is a part of a fenestration and, specifically, one of the frame counterparts of a window.

In some embodiments, for example, the low emissivity material includes any metal known to be capable of achieving low-emissivity performance. In some embodiments, for example, the low emissivity material includes at least one material selected at least one selected from a group consisting of silver, gold, copper, aluminum, platinum, ion-doped metal oxide, and any combination thereof. In some embodiments, for example, the ion doped metal oxide is any one of indium tin oxide, fluorine doped tin oxide, aluminum doped zinc oxide, and gallium zinc oxide. In some embodiments, for example, the low emissivity material has an emissivity of less than 0.5.

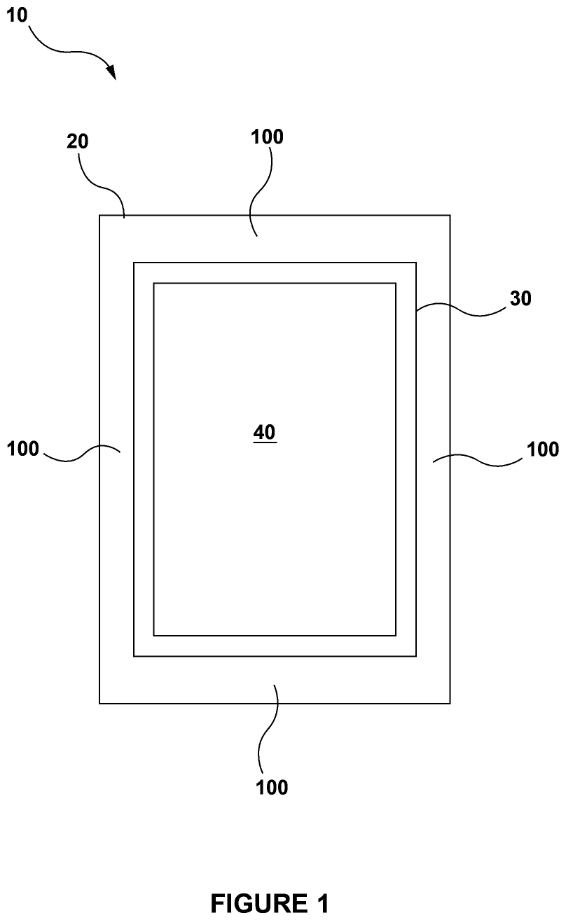

FIG. 1 depicts a window 10. In some embodiments, for example, the window 10 includes a frame 20, a sash 30, and one or more glass panes 40. In some embodiments, for example, the window frame 20 includes a plurality of frame counterparts 100 that are co-operable for assembly to establish the window frame 20. As depicted, the glass pane 40 is disposed in the sash 30, and the sash 30 is disposed in the window frame 20. In some embodiments, for example, the frame 20 supports the sash 30, which supports the glass pane 40.

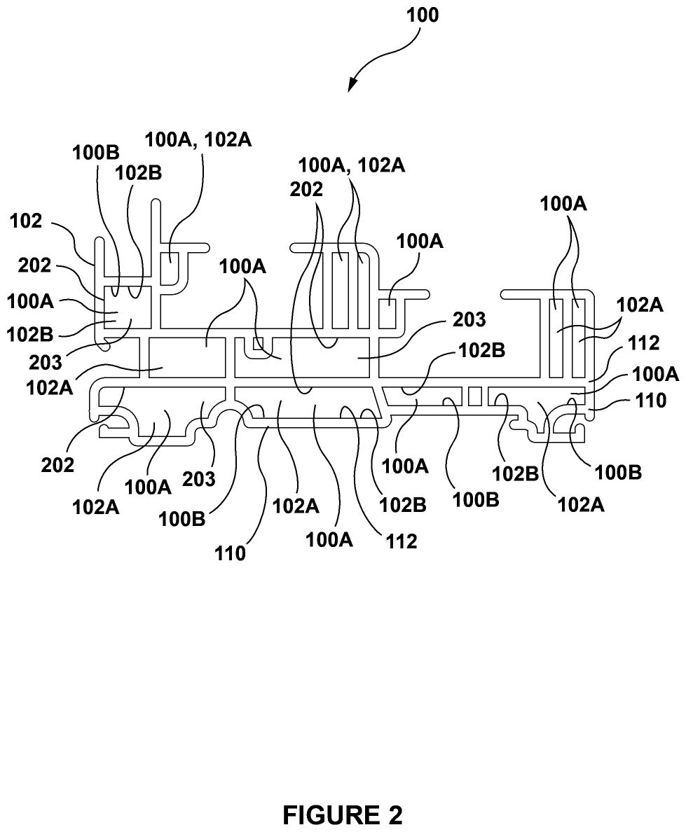

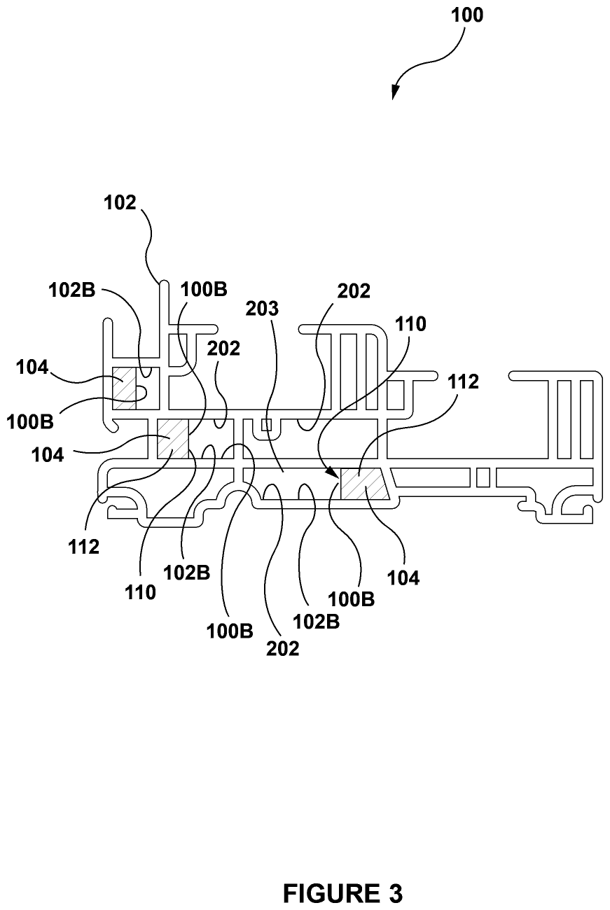

FIGS. 2 and 3 are cross-sectional elevation views of different embodiments of the frame counterpart 100.

In some embodiments, for example, the frame counterpart 100 includes a frame member 102. In some embodiments, for example, the frame counterpart 100 is defined by a frame member 102. In some embodiments, for example, the material of construction of the frame member 102 is plastic, such as, for example, polyvinyl chloride. In some embodiments, for example, the material of construction of the frame member 102 is aluminium. In some embodiments, for example, the material of construction of the frame member 102 is fiberglass.

In some embodiments, for example, the frame member 102 is manufactured by extrusion, pulltrusion, blow moulding, or injection moulding. In some embodiments, for example, the frame member 102 is an extruded lineal.

In some embodiments, for example, the frame counterpart 100 includes a plurality of frame counterpart-defined internal cavities 100A. Each one of the frame counterpart-defined internal cavities 100A, independently, is defined by a frame counterpart cavity-defining internal wall configuration 110, defined by a plurality of frame counterpart cavity-defining internal walls 100B, of the frame counterpart 100, wherein the plurality of walls 100B are co-operatively joined to establish the cavity 100A. In some embodiments, for example, the frame member 102 includes a plurality of frame member-based internal cavities 102A. Each one of the plurality of frame member-based internal cavities 102A, independently, is defined by a frame member cavity-defining internal wall configuration 110A, defined by frame member cavity-defining internal walls 102B, of the frame member 102, joined together to establish the cavity 102A.

Referring to FIG. 2, in some embodiments, for example, the frame counterpart-defined internal cavity 100A is defined by the frame member cavity-defining internal walls 102B of the frame member 102, such that the frame counterpart-defined internal cavity 100A is defined by the frame member-based internal cavity 102A of the frame member 102.

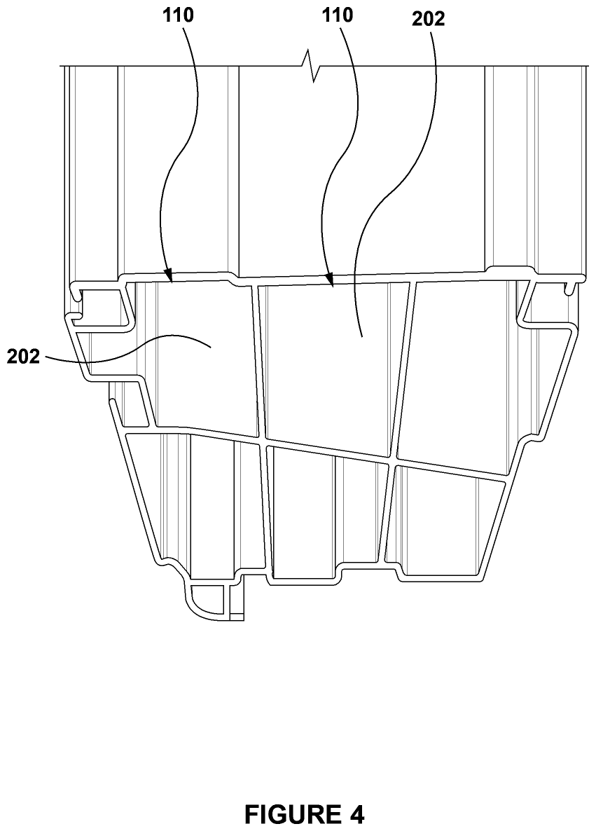

Referring to FIGS. 2, 3, and 4 in some embodiments, for example, at least a portion of the surface of the frame counterpart cavity-defining internal wall configuration 110 is defined by a low-emissivity material 202, such that the definition of a surface within the cavity 100A, by the low emissivity material 102, includes the definition of at least a portion of the surface of the frame counterpart cavity-defining internal wall configuration 110 by the low-emissivity material 202. In some embodiments, for example, the frame counterpart cavity-defining internal wall configuration 110 defines a total surface area of SA_{IWG}, and at least 50% (such as, for example, at least about 60%, such as, for example, at least 70%, such as, for example, at least 80%, such as, for example, at least 90% of the total surface area SA_{IWG}) of the total surface area is defined by low-emissivity material 202. In some embodiments, for example, the air space 203 is disposed adjacent to the low emissivity material 202 and extends from the low emissivity material 202 to an opposing surface of the frame counterpart cavity-defining internal wall configuration 110 (which, in some embodiments, is defined by another portion of the low emissivity material 202).

In some embodiments, for example, the frame counterpart cavity-defining internal wall configuration 110 includes the low emissivity material 202 and a wall configuration substrate 112, and the low emissivity material 202 is disposed on the wall configuration substrate 112, such that the low emissivity substrate defines at least a portion of the frame counterpart cavity-defining internal wall configuration 110. In some embodiments, for example, the wall configuration substrate 112 includes plastic material, such as, for example, polyvinyl chloride. In some embodiments, for example, the wall configuration substrate 112 is defined by an extrusion. In some embodiments, for example, the wall configuration substrate 112 is defined by the frame member 110.

In some embodiments, for example, the low emissivity material 202 is disposed as a layer of low emissivity material 202 on the wall configuration substrate 112. In some of these embodiments, for example, the low emissivity material 202 is adhered to the wall configuration substrate 112. In some of these embodiments, for example, the adherence of the low emissivity material 202 to the wall configuration substrate 112 is obtained by coating of a low emissivity precursor material 202 (e.g. a coating, such as, for example, a paint) on the wall configuration substrate 112 and, in some of these embodiments, for example, is obtained by coating of a low emissivity material precursor on the frame member 110. In this respect, the low-emissivity material 202 is derived from the low-emissivity material precursor 202, and, in some embodiments, for example the low-emissivity material 202 is obtained in response to curing of the low-emissivity material precursor. In some embodiments, for example, the low-emissivity material 202 is the low-emissivity material precursor. In some embodiments, for example, the low-emissivity material precursor is a water-based radiant barrier coating. In some embodiments, for example, the low-emissivity material precursor is a solvent-based (e.g. organic solvent-based) radiant barrier coating. In some embodiments, for example, a suitable low-emissivity material precursor is LO/MIT-I MAX™ radiant barrier coating which is available from SOLEC-Solar Energy Corp. of Ewing, New Jersey, U.S.A.

In some embodiments, for example, the layer of the low emissivity material 202, disposed on the wall configuration substrate 112, has a minimum thickness of at least 1.5/1000 of an inch. In some of these embodiments, for example, the minimum thickness is within a range, and the range is from 1.5/1000 of an inch to 5/1000 of an inch.

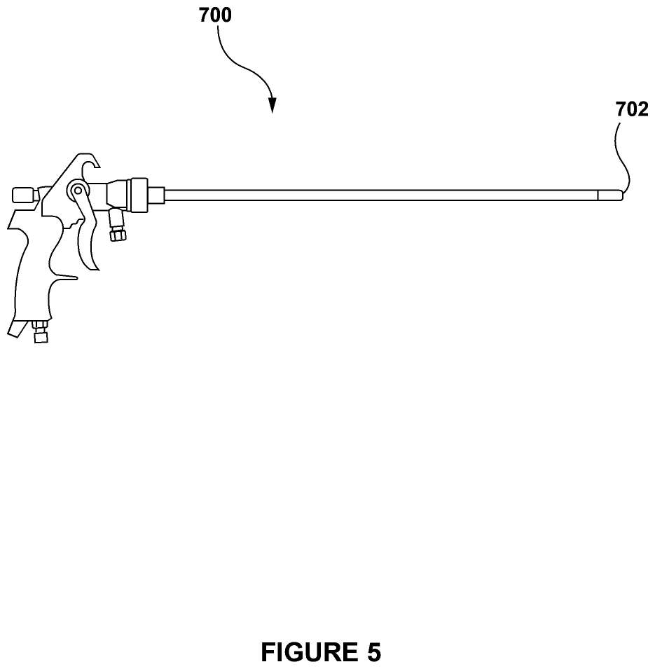

In some embodiments, for example, the emplacement of the low emissivity material 202 within the cavity 100A is effectuated by spray-coating of the low-emissivity material pre-cursor onto the at least a portion of the wall configuration substrate 112 (such as, for example, a portion of the frame member 110) of the frame counterpart cavity-defining internal wall configuration 110. In this respect, in some embodiments, for example, the low-emissivity material pre-cursor has a viscosity effective for discharge through a spray nozzle via conduction through a passage having a length, along its longitudinal axis, of at least 10 feet (such as, for example, at least 15 feet), and having a maximum cross-sectional area of less than 0.1 square inches, such as, for example, less than 0.049 square inches. The spray nozzle is moved through the cavity 100A so as to distribute the sprayed low-emissivity material precursor onto different portions of the wall 100B, such as, for example, across the entirety of the wall 100B. Referring to FIG. 5, in some embodiments, for example, the spray nozzle 702 is defined at a terminal end of a 360 degree spray gun 700 which has an extension which defines an elongated tube 704 for conducting the low emissivity material precursor for discharge via the nozzle 702.

Alternatively, in some embodiments, for example, the emplacement of the low emissivity material 202 within the cavity 100A is effectuated by pouring of the low emissivity material precursor within a cavity defined by the wall configuration substrate 112 (such as, for example the cavity 102B defined within the frame member 102). In some embodiments, for example, residual low emissivity material is collected and recirculated (e.g. by a pump) for an additional pass through the cavity defined by the wall configuration substrate 112.

Referring to FIG. 3, in some embodiments, for example, the frame counterpart-defined internal cavity 100A is partly defined by thermally-insulating material 104 (such as a foam) disposed within the member-defined internal cavity 102A of the frame member, such that at least one or more of the frame counterpart cavity-defining internal walls 100B, of the frame counterpart 100, is defined by the thermally-insulating material, while at least portions of one or more of the frame counterpart cavity-defining internal walls 100B are defined by low emissivity material 202 (for example, by virtue of being coated on at least a portion of an internal wall 102B of the frame member 102). The thermally-insulating material 104 and the low emissivity material 202 are co-operatively configured such that the air space 203 is defined within the cavity 100A.

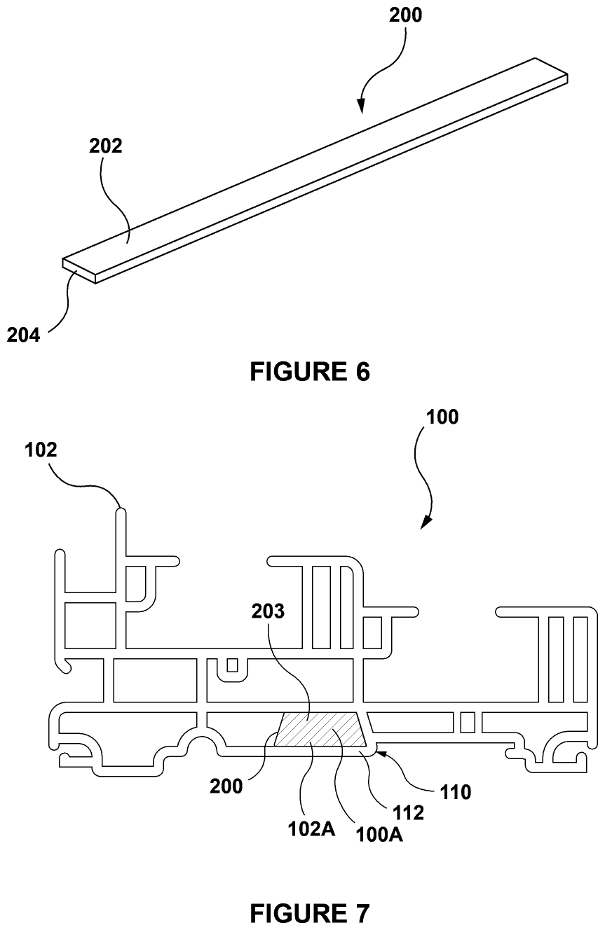

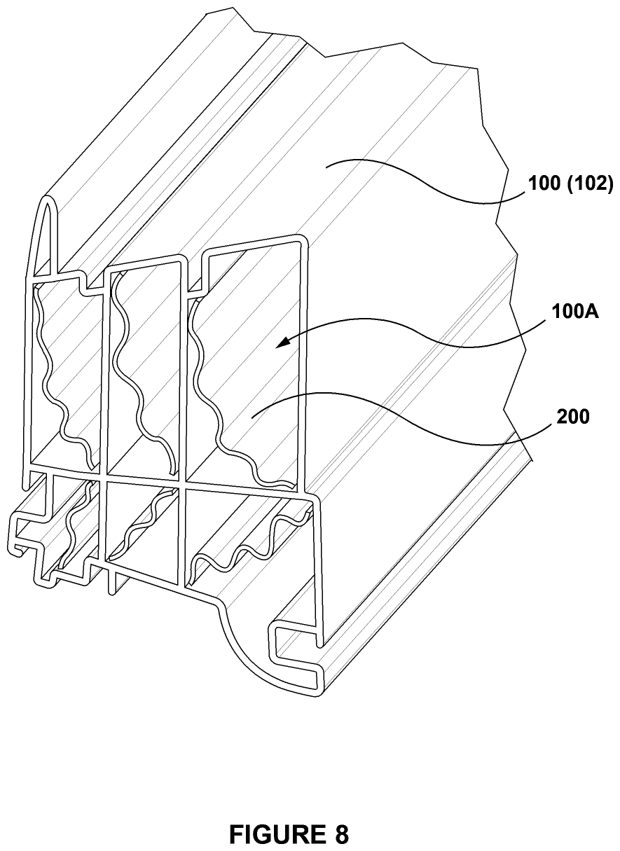

Referring to FIGS. 6, 7, and 8, in some embodiments, for example, the disposition of the low emissivity material 202 within the cavity 100A is effectuated by disposition of an insert 200 within the cavity 100A, wherein the insert 200 has a surface defined by the low emissivity material 202. In some of these embodiments, the cavity 100A is defined by the member cavity-defining internal walls 102B of the frame member 102, such that the frame counterpart-defined internal cavity 100A is defined by the frame member-defined internal cavity 102A of the frame member 102, and, in this respect, in some embodiments, for example, the insert 200 is disposed within the cavity 102B. In some of these embodiments, for example, the insert 200 is emplaced within the cavity 100A (e.g. the cavity 102B). In some embodiments, for example, the disposition of the low emissivity material 202 within the cavity 100A is such that there is an absence of adherence of the low emissivity material 202 to a wall configuration substrate 112 (e.g. the frame member 102), and such that there is an absence of definition of any portion of the surface of the frame counterpart cavity-defining internal wall configuration 110 by the low-emissivity material 202. In this respect, the disposition of the insert 200 within the cavity 100 (e.g. the cavity 102B) is such that the definition of a surface within the cavity 100A, by the low emissivity material 102, includes definition by a surface of the insert 200.

In some embodiments, for example, the low emissivity material 202, of the insert 200, and the frame counterpart cavity-defining internal wall configuration 110 (e.g. the frame member cavity-defining internal wall configuration 110A) are co-operatively configured such that the air space 203 is defined by a space extending from the insert 200 to the frame counterpart cavity-defining internal wall configuration 110.

In some embodiments, for example, the disposition of the insert 200 within the cavity 100A includes a coupling of the insert 200 to the component-based cavity-defining internal wall configuration 110 (e.g. the frame member cavity-defining internal wall configuration 110A). In some embodiments, for example, the coupling of the insert 200 to the component-based cavity-defining internal wall configuration 110 (e.g. frame member 102) is effectuated via coupling of the composite insert 200 to the frame counterpart cavity-defining internal wall configuration 110 (e.g. the frame member cavity-defining internal wall configuration 110A). In some embodiments, for example, the coupling is established based on an interference fit relationship between the insert 200 and component-based cavity-defining internal wall configuration 110 (e.g. the frame member cavity-defining internal wall configuration 110A). In this respect, in some embodiments, for example, the insert 200 is flexible (such as, for example, deformable, such as, for example, bendable) for assisting with emplacement of the insert 200 within the cavity 100A (e.g. the cavity 102B). In some of these embodiments, the composite insert 200 is resilient. In some embodiments, for example, the insert 200 is configured to co-operate with the component-based cavity-defining internal wall configuration 110 (e.g. the frame member cavity-defining internal wall configuration 110A) such that disposition of the insert 200 within the cavity 100A (e.g. the cavity 102B) is in the absence of fastening of the insert 200 to the component-based cavity-defining internal wall configuration 110 (e.g. the frame member cavity-defining internal wall configuration 110A) with a fastener.

In some embodiments, for example, the insert 200 includes composite material, and, in this respect, the insert 200 includes low emissivity material 202 coupled to a substrate material 204. In some embodiments, for example, the low emissivity material 202 of the insert 200 is in the form of a layer. In some embodiments, for example, the substrate material 204 is in the form of a layer. In some embodiments, for example, the insert 200 includes a layer of the low emissivity material 202 disposed on a first side of the substrate material 204, and a second layer of low emissivity material 202 disposed on a second side of the substrate material 204, wherein, relative to the first side, the second side is on an opposite of the substrate material 204. In this respect, in some embodiments, for example, the low emissivity material 202 is disposed on opposite sides of the substrate material 204. In some embodiments, for example, the substrate 204 includes (and, in some embodiments, is) plastic material. In some embodiments, for example, the plastic material includes polyvinyl chloride. In some embodiments, for example, the plastic material includes re-grind material. In some embodiments, for example, the insert 200 also functions as reinforcement, and, in some of these embodiments, the substrate is fiberglass, wood, or steel. In some of these embodiments, for example, the substrate 204 is in the form of an extrusion.

In some embodiments, for example, the minimum thickness of the insert 200 is at least 21.5/1000 of an inch, such as, for example, at least 26.5/1000 of an inch, such as, for example, at least 31.5/1000 of an inch. In some embodiments, for example, the insert has a thickness that is less than, or equal to, 70/1000 of an inch. In some of these embodiments, for example, the minimum thickness is within a range from 21.5/1000 of an inch to 70/1000 of an inch.

In some embodiments, for example, for each one of the layers of the low emissivity material 202, independently, the minimum thickness of the layer of the low emissivity material 202 is at least 1.5/1000 of an inch. In some of these embodiments, for example, the minimum thickness is within a range from 1.5/1000 of an inch to 5/1000 of an inch.

In some embodiments, for example, the insert 200 is in the form of a strip, and, in some of these embodiments, for example, a corrugated strip 200. In some embodiments, for example, by having a corrugated surface, as opposed to a planar surface, the insert 200 is afforded increased surface area across which energy can be reflected by the low emissivity material over the same linear distance. Also, in some embodiments, by having a corrugated surface, as opposed to a planar surface, the insert 200 is easier to shape and re-shape to conform for insertion into a cavity. In some embodiments, for example, the corrugated surface is defined by alternating peaks and valleys, and, for each one of the peaks, independently, a respective score line is defined within the outer surface surface of the peak, and, for each one of the valleys, a respective score line is defined within the outer surface of the valley.

In some embodiments, for example, the low emissivity material 202 is adhered to the substrate material 204. In some of these embodiments, for example, the low emissivity material is coated onto the substrate material 204. In some embodiments, for example, the coating is effectuated manually with a spray gun. In some embodiments, for example, the coating is effectuated by an automatic linear spray machine, such as, for example, a PERFORMA™ linear spraying machine which is available from Cefla Finishing, which is a business that is operated by Cefla s.c. of Imola, Italy. In some embodiments, for example, the adherence is via an adhesive. In some embodiments, for example, the coupling is via lamination (such as in some of those embodiments where the low emissivity material include aluminium material). In embodiments, for example, the substrate 204 and the low emissivity material are co-operatively configured such that the low emissivity material 202 seals the substrate 204.

In some embodiments, for example, low emissivity material 202 includes (and, in some of these embodiments, for example, is) aluminum that is coupled to the substrate 204. In some embodiments, for example, the aluminium is in the form of aluminium foil. In some embodiments, for example, the aluminum is laminated onto the substrate 204. In this respect, in some embodiments, for example, the insert 200 is aluminized bubble wrap. In some embodiments, for example, the substrate 204 is plastic material, such as polyvinyl material, and the low emissivity material 202 includes (and, in some of these embodiments, for example, is) aluminium. In some embodiments, for example, the insert 200 includes a layer of plastic material (e.g. a polyvinyl chloride extrusion), functioning as the substrate 204, interposed between layers of the aluminium.

In some embodiments, for example, at least a portion of the surface of the composite insert 200 is defined by low emissivity material. In some embodiments, for example, the low emissivity material defines at least 50% of the total surface area of the composite insert 200, such as, for example, at least 60% of the total surface area of the composite insert 200, such as, for example, at least 70% of the total surface area of the composite insert 200, such as, for example, at least 80% of the total surface area of the composite insert 200, such as, for example, at least 90% of the total surface area of the composite insert 200.

In some embodiments, for example, the composite insert 200 includes at least a surface portion, defined by low emissivity material, that has a total surface area of SA_{LEM}, and the ratio of SA_{LEM} to SA_{IWG} (as defined above, SA_{IWG} is the total surface area of the frame counterpart cavity-defining internal wall configuration 110) is at least 0.25, such as, for example, at least 0.5, such as, for example, at least 0.75, such as, for example, at least 1.0.

It is understood that the frame counterpart 100 is not strictly limited to use in assembling a window 10, and that the frame counterpart 100 can be used to assemble other kinds of fenestrations.

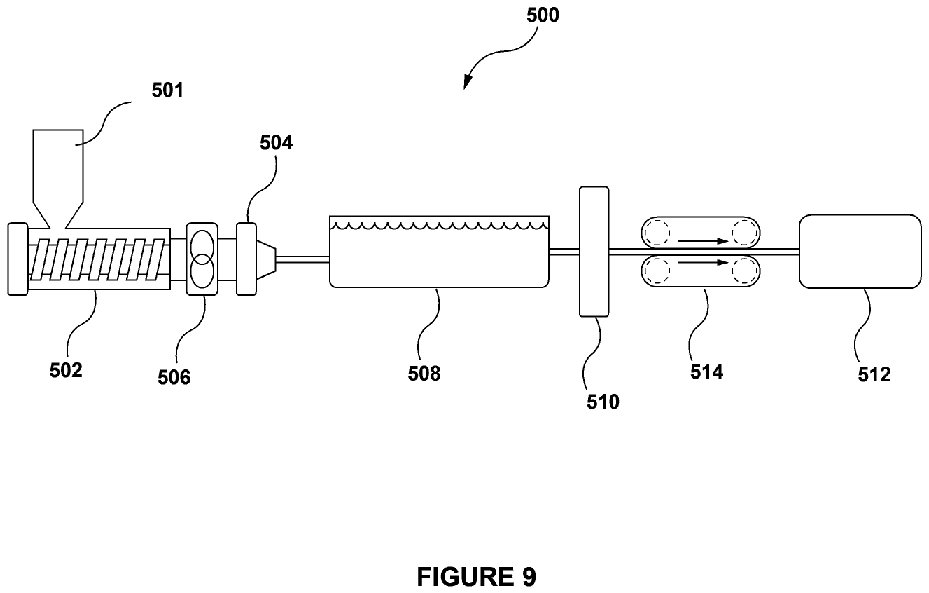

In some embodiments, for example, the substrate material 204 of the insert 200 is plastic material, such as, for example, polyvinyl chloride, and the plastic material is an extrusion. A system 500 for implementing a typical extrusion process, for producing an extrusion product, from which the substrate material 204 is derived, is illustrated in FIG. 9. The resin is supplied to the extruder via the dryer 501 (where the resin is suitably dried). Within the extruder, heat and shear are applied by the extruder 502 to melt and mix the plastic resin, and the melted plastic is forced through the die 504. In some embodiments, for example, a pump 506 is also used for boosting the pressure of the melted plastic so that the pressure is suitable for flow through the die 504 to produce an intermediate product. The extruded product is cooled via the cooling tank 508 to produce a cooled intermediate product. Between the die and the cooling tank, vacuum is applied to the intermediate product to maintain its shape, while, in parallel, also cooling the intermediate product. Dimensions of the cooled intermediate product are checked with the diameter gauge 510 to confirm that the cooled intermediate product is of a suitable quality. Once the quality of the cooled intermediate product is confirmed, the cooled intermediate product is fed into a cutter 512 for effectuating cutting of the cooled intermediate product to a desirable length, with effect that the extruded product is produced. The displacement of the intermediate product from the extrusion die 504 to the cutter 512 is effectuated by the puller.

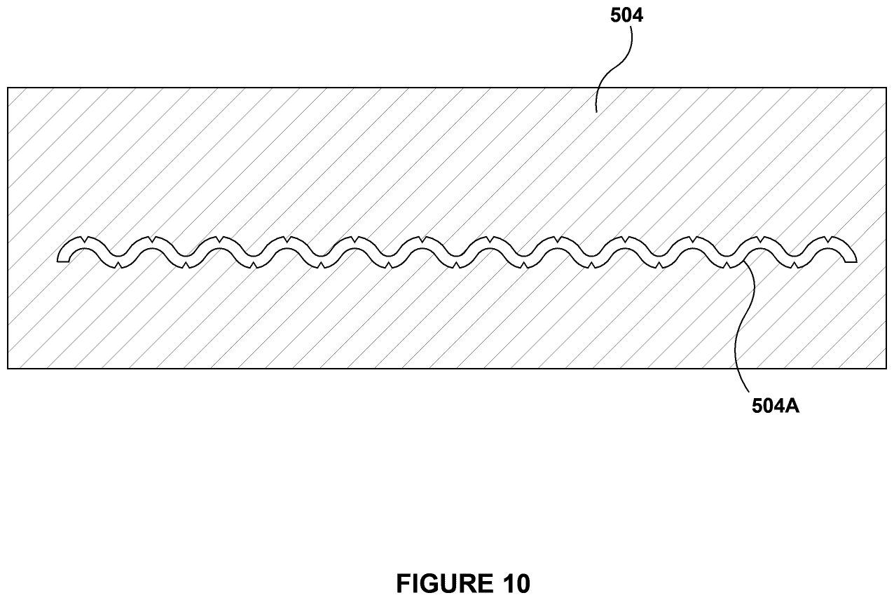

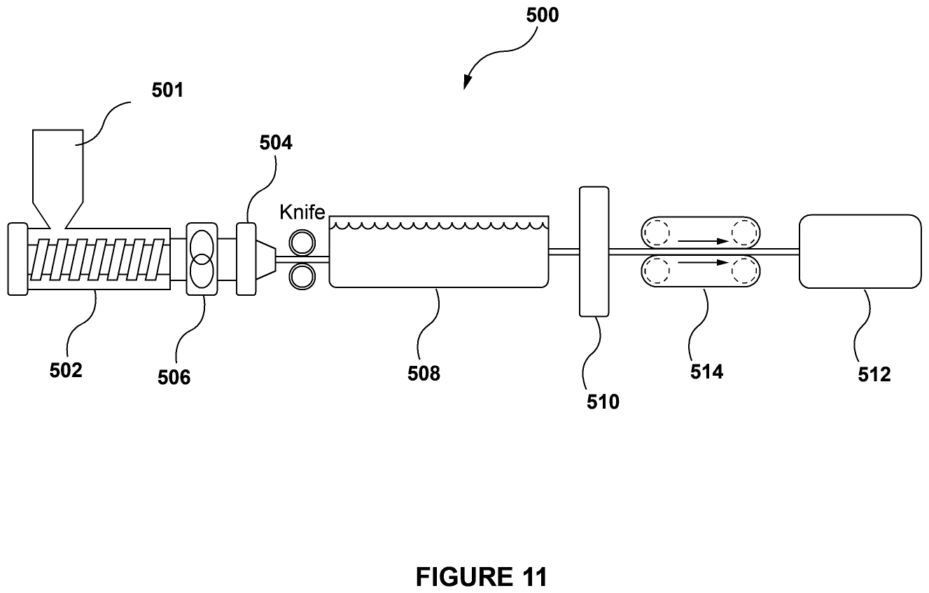

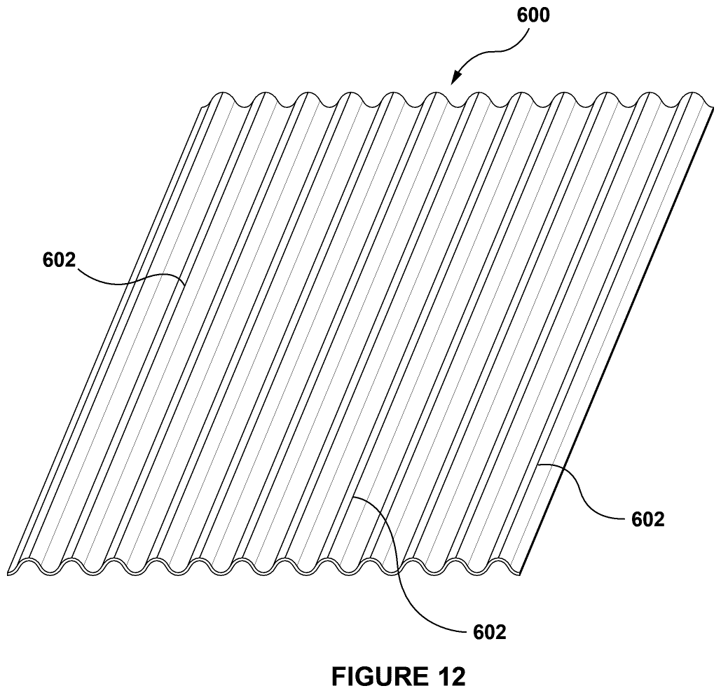

In some embodiments, for example, the extrusion die 504 is configured to co-operate with the plastic material that is being extruded such that the intermediate product (and, eventually, the extruded product, which defines the substrate material 204) is scored by the exit template 504A of the extrusion die 504 (see FIGS. 9 and 10), with effect that a plurality of axially spaced score lines (e.g. notches) are defined on the intermediate product, and with effect that the produced extrusion product is a scored extrusion product. Referring to FIG. 11, alternatively, in some embodiments, for example, instead of scoring the intermediate product at the extrusion die, the scoring is effectuated downstream of the extrusion die, between the extrusion die and the cooling tank, by a separate scoring apparatus which includes a knife.

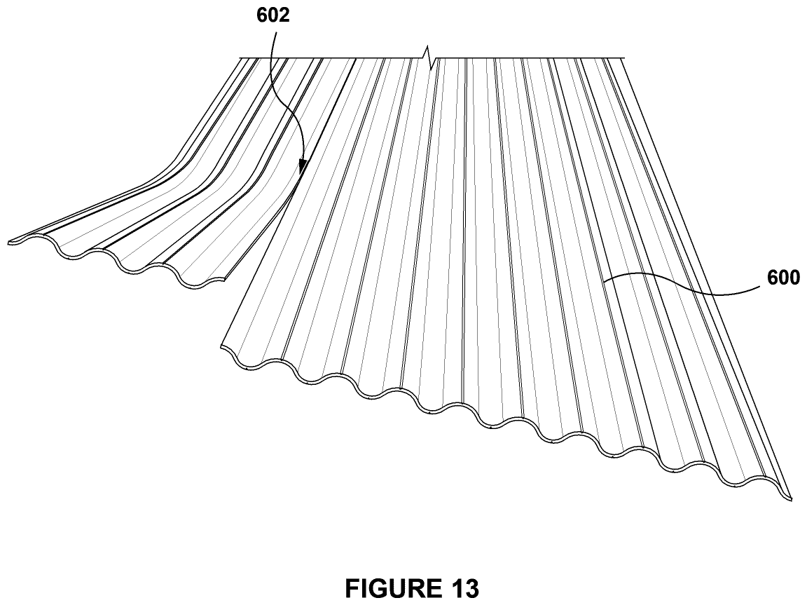

In some embodiments, for example, adjacent ones of the score lines are spaced apart by a minimum spacing distance of at least 50/1000 of an inch, such as, for example, 75/1000 of an inch, such as, for example, at least 100/1000 of an inch. One or more surfaces, or surface portions, of the scored extrusion product is then coated with the low emissivity material precursor, with effect that a multiple-insert source material 600, including the plurality of axially spaced score lines 602, is produced (see FIG. 12). In some embodiments, for example, the score lines 602 are disposed in parallel relationship with each other. The insert 200 is obtainable from the multiple-insert source material 600 by detachment (such as, for example, by snapping, tearing, or cutting) along a selected one of the score lines 602 to obtain the insert 200 of a predetermined width that is based on the selected one of the score lines 602 along which the detachment is effectuated (see FIG. 13. In parallel, and in response to the detachment, a remaining portion of the multiple-insert source material is obtained, and, in some embodiments, functions as source from which other inserts 200 can be detached and obtained in a similar manner. In this respect, the selection of the score line 602 to be snapped, cut, or torn determines the width of the insert 200. The selected score line 602 along which the detachment is effectuated corresponds to a side edge of the obtained insert 200. In this respect, one or more inserts 200 are obtainable from the multiple-insert source material 600.

In some embodiments, for example, the surface of the source material 600 is scored such that one or more portions of the source material is detachable from the source material, such that, detachment of one portion from the source material is with effect that: (i) the detached portion has at least a surface portion that is defined by low emissivity material, and (ii) a remaining portion of the multiple-insert source material is obtained, wherein the remaining portion has a surface portion that is defined by low emissivity material.

Referring to FIG. 12, in some embodiments, for example, the multiple-insert source material 600 is in the form of a sheet. In some embodiments, for example, with the exception of the score lines 602, and any notches that define the score lines 602, the sheet has a thickness of at least 21.5/1000 of an inch, such as, for example, at least 26.5/1000 of an inch, such as, for example, at least 31.5/1000 of an inch. In some embodiments, for example, the sheet has a thickness that is less than, or equal to, 70/1000 of an inch. In some embodiments, for example, the sheet has a width of at least one (1) inch, such as, for example, at least 5.5 inches. In some embodiments, for example, the sheet has a length of at least ten (10) feet, and, in some of these embodiments, the length is within a range, and the range is from 10 feet to 25 feet.

The preceding discussion provides many example embodiments. Although each embodiment represents a single combination of inventive elements, other examples may include all suitable combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be examples only. The invention is defined by the appended claims.

1. A structural component for use in a building structure, including an internal cavity, defined by a component-based cavity-defining internal wall configuration, comprising low emissivity material disposed within the cavity such that the low emissivity material defines a surface within the cavity.

2.-38. (canceled)

39. The structural component as claimed in claim 1;
wherein:
at least a portion of a surface of the component-based cavity-defining internal wall configuration is defined by the low-emissivity material, such that the definition of a surface within the cavity includes definition of at least a portion of a surface of the component-based cavity-defining internal wall configuration by the low emissivity material.

40. The structural component as claimed in claim 39;
wherein:
the component-based cavity-defining internal wall configuration defines a total surface area of SA_{IWG}, and at least 50% of the total surface area is defined by low-emissivity material or wherein the component-based cavity-defining internal wall configuration includes the low emissivity material and a wall configuration substrate, and the low emissivity material is disposed on the wall configuration substrate or wherein the low emissivity material that is disposed on the wall configuration substrate is adhered to the substrate material and further wherein the adherence of the low emissivity material to the wall configuration substrate is obtained by coating of a low emissivity precursor material on the wall configuration substrate.

41. The structural component as claimed in claim 1;
wherein:
the disposition of the low emissivity material within the cavity includes disposition of an insert within the cavity such that the definition of a surface within the cavity includes definition by a surface of the insert.

42. The structural component as claimed in claim 41;
wherein:
the disposition of the insert within the cavity includes a coupling of the composite insert to the component-based cavity-defining internal wall configuration.

43. The structural component as claimed in claim 41;
wherein:
the coupling is established based on an interference fit relationship between the composite insert and the component-based cavity-defining internal wall configuration.

44. The structural component as claimed in claim 41;
wherein:
the insert includes composite material; and
the composite material includes low emissivity material that is coupled to a substrate material.

45. The structural component as claimed in claim 44;
wherein:
the low emissivity material is adhered to the substrate material.

46. The structural component as claimed in claim 44;
wherein:
at least a portion of the surface of the insert is defined by low emissivity material; and
the low emissivity material defines at least 50% of the total surface area of the composite insert.

47. The structural component as claimed in claim 44;
wherein:
the component-based cavity-defining internal wall configuration defines a total surface area of SA_{IWG}; and
the insert includes at least a surface portion, that is defined by low emissivity material, and that has a total surface area of SA_{LEM}, and the ratio of SA_{LEM} to SA_{IWG} is at least 0.25.

48. The structural component as claimed in claim 44;
wherein:
the component-based cavity-defining internal wall configuration defines a total surface area of SA_{IWG}; and
the insert includes at least a surface portion, that is defined by low emissivity material, and that has a total surface area of SA_{LEM}, and the ratio of SA_{LEM} to SA_{IWG} is at least 0.5.

49. The structural component as claimed in claim 44;
wherein:
the component-based cavity-defining internal wall configuration defines a total surface area of SA_{IWG}; and
the composite insert includes at least a surface portion, that is defined by low emissivity material, and that has a total surface area of SA_{LEM}, and the ratio of SA_{LEM} to SA_{IWG} is at least 0.75.

50. The structural component as claimed in claim 44;
wherein:
the disposition of the low emissivity material within the cavity is such that there is an absence of definition of any portion of the surface of the frame counterpart cavity-defining internal wall configuration by the low-emissivity material.

51. The structural component as claimed in claim 44;
wherein:
the low emissivity material includes a layer of low emissivity layer coupled to the substrate, and the layer has a minimum thickness of at least 1.5/1000 of an inch or wherein the low emissivity material, of the insert, and the component-based cavity-defining internal wall configuration are co-operatively configured such that the air space is defined by a space extending from the insert to the component-based cavity-defining internal wall configuration or wherein: the low emissivity material has an emissivity of less than 0.5.

52. The structural component as claimed in claim 44;
wherein:
the minimum thickness of the insert is at least 21.5/1000 of an inch or wherein the minimum thickness of the insert is less than, or equal to, 70/1000 of an inch or wherein the insert is in the form of a strip.

53. The structural component as claimed in claim 44;
wherein:
the structural component is one of the frame counterparts of a window.

54. A composite insert for emplacement within a cavity of a frame member of a structural component for use in a building structure, comprising low emissivity material that is coupled to a substrate material.

55. The composite insert as claimed in claim 54;
wherein:
the low emissivity material is adhered to the substrate material or wherein at least a portion of the surface of the insert is defined by low emissivity material, and the low emissivity material defines at least 50% of the total surface area of the composite or wherein: the insert has a minimum thickness of at least 21.5/1000 of an inch or wherein the insert has a minimum thickness of less than, or equal to, 70/1000 of an inch or wherein the low emissivity material includes a layer of low emissivity layer coupled to the substrate, and the layer has a minimum thickness of at least 1.5/1000 of an inch or wherein the insert is in the form of a strip or wherein the substrate material includes plastic material. Or wherein the composite insert is deformable or wherein the low emissivity material has an emissivity of less than 0.5.

56. A multiple insert source material including a composite material, comprising:
low emissivity material that is coupled to a substrate material such that the low emissivity material defines at least a portion of a surface of the source material;
wherein:
the surface is scored such that one or more portions of the source material is detachable from the source material, such that, detachment of one portion from the source material is with effect that: (i) the detached portion has at least a surface portion that is defined by low emissivity material, and (ii) a remaining portion of the multiple-insert source material is obtained, wherein the remaining portion has a surface portion that is defined by low emissivity material.

57. The multiple insert source material as claimed in claim 56;
wherein:
the multiple-insert source material is in the form of a sheet or wherein the sheet has a thickness that is less than, or equal to, 70/1000 of an inch or wherein and wherein the low emissivity material has an emissivity of less than 0.5.
